(19) United States
(12) Patent Application Publication
(10) Pub. No.: US 2005/0013251 A1
(43) Pub. Date: Jan. 20, 2005

(54) Flow control hub having scoreboard memory

(76) Inventors: Hsuan-Wen Wang, Sunnyvale, CA (US); Jaisimha Bannur, Sunnyvalo, CA (US); Anujan Varma, Santa Cruz, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/622,806

(22) Filed: Jul. 18, 2003

(51) Int. Cl. H04L 12/26

(52) U.S. Cl. 370/235; 370/428

(57) ABSTRACT

In general, in one aspect, the disclosure describes a flow control hub that includes a scoreboard memory device to maintain flow control status for a plurality of flows. Each of the flows is identified by an associated index. The apparatus also includes an address decoder to receive a flow control message and to determine an associated index based on the address portion. The apparatus further includes an updater to update the flow control status in said memory device based on the received flow control message.

### BACKGROUND

Store-and-forward devices, such as switches and routers, include a plurality of ingress ports for receiving data and a plurality of egress ports for transmitting data. The data received by the ingress ports is queued in a queuing device, and subsequently dequeued from the queuing device, as a prelude to its being sent to an egress port. Each queue is associated with a flow (transfer of data from source to destination under certain parameters). The flow of data may be accomplished using any number of protocols including Asynchronous Transfer Mode (ATM), Internet Protocol (IP), and Transmission Control Protocol/IP (TCP/IP). The flows may be based on parameters such as the egress port, the ingress port, class of service, and the protocol associated with the data. Therefore, an ingress port may maintain a large number of queues (e.g., one per flow).

When data is selected from the queue for transmission, it is sent over a backplane to the appropriate egress ports. The data received at the egress ports is queued in a queuing device before being transmitted therefrom. The queuing device can become full if messages are coming in faster than they are being transmitted out. In order to prevent the queues from overflowing, and thus losing data, the egress port needs to indicate to one or more ingress ports that they should stop sending data. This is accomplished by sending flow control messages from the egress ports to ingress ports where the traffic originates. The flow control message can be an ON status or an OFF status for ON/OFF flow control, or it can be a value for more general flow control. An OFF message indicates that the traffic belonging to one or more flows need to be throttled and an ON message indicates that the corresponding queue in the ingress line card can send traffic again. Such flow control messages may be sent to individual ingress ports or broadcast to a plurality of (e.g., all) the ingress ports.

Often, there is a separate control path for transmitting the flow control messages. It is expensive to have a mesh of connections for transmitting flow control messages from the egress ports to the ingress ports. Therefore, a central flow control hub is used to gather (queue) the messages from the egress ports and distribute them to the ingress ports. Traditionally, the flow control messages are queued in FIFOs. As the number of ports in a router or switch goes up, the worst-case number of flow control messages that need to be sent to individual ingress ports or broadcast to all ingress ports also goes up. The control-plane bandwidth available for delivering flow control messages cannot usually match the worst case needs and is limited to keep the system simple and cost-effective. Thus, limiting the bandwidth that is provided for transmission of flow control messages can result in excessive latency of transmission or loss of flow control messages. When the ingress port does not receive a timely message indicating that one or more egress ports are congested, it continues to send traffic to the congested egress port or ports. The egress ports usually have a scheme that assumes the flow control message has been lost if the ingress port does not respond and continues to send traffic. In this case, the egress line card will resend the flow control message. This can result in a flood of flow control messages that are either lost or suffer lengthy queuing delays, further exacerbating the congestion.

With many small FIFOs, the flow control messages can build up very fast and overflow under severe operating conditions. On the other hand, if a single large FIFO is used, the flow control message may be delayed for a long period of time before being delivered, thus triggering the source of the message to resend the message multiple times.

### BRIEF DESCRIPTION OF THE DRAWINGS

The features and advantages of various embodiments will become apparent from the following detailed description in which:

FIG. 1A illustrates an exemplary block diagram of a store-and-forward device, such as a packet switch or router, according to one embodiment;

FIG. 1B illustrates an exemplary detailed block diagram of the store and-and-forward device, according to one embodiment;

FIG. 1C illustrates an exemplary detailed block diagram of the store and-and-forward device, according to one embodiment;

FIG. 2 illustrates an exemplary flow control message, according to one embodiment;

FIG. 3 illustrates an exemplary flow control hub, according to one embodiment;

FIG. 4 illustrates and exemplary scoreboard memory, according to one embodiment;

FIG. 5 illustrates an exemplary flowchart for queuing flow control messages, according to one embodiment; and

FIG. 6 illustrates an exemplary flowchart for de-queuing flow control messages, according to one embodiment.

### DETAILED DESCRIPTION

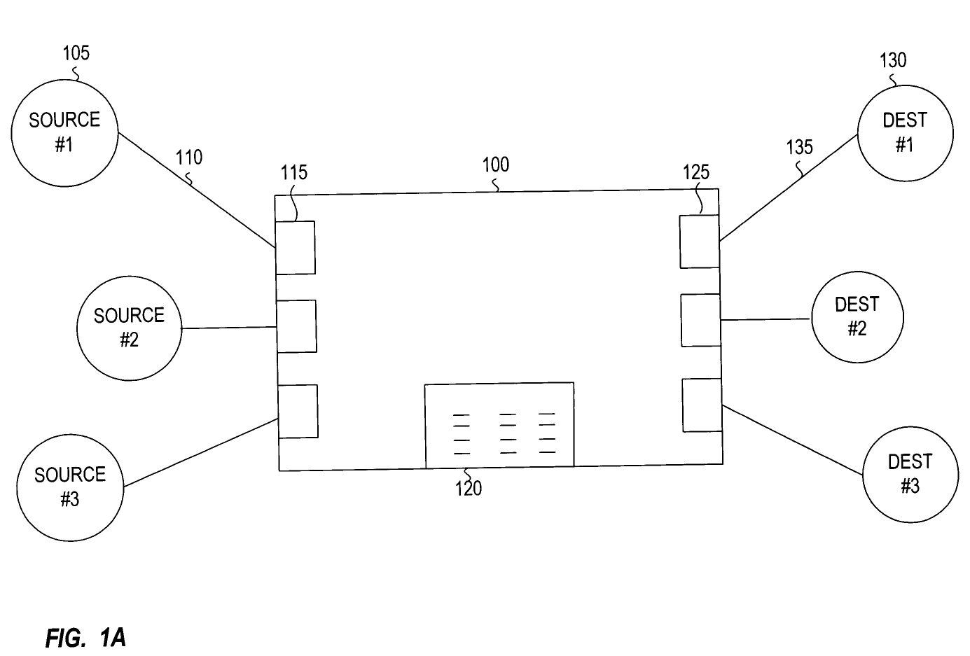

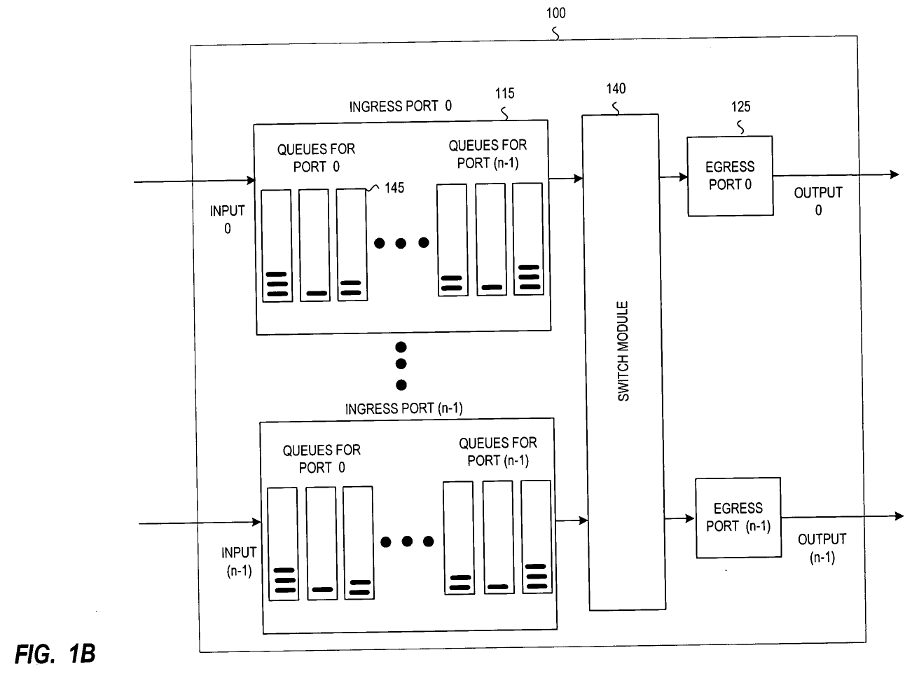

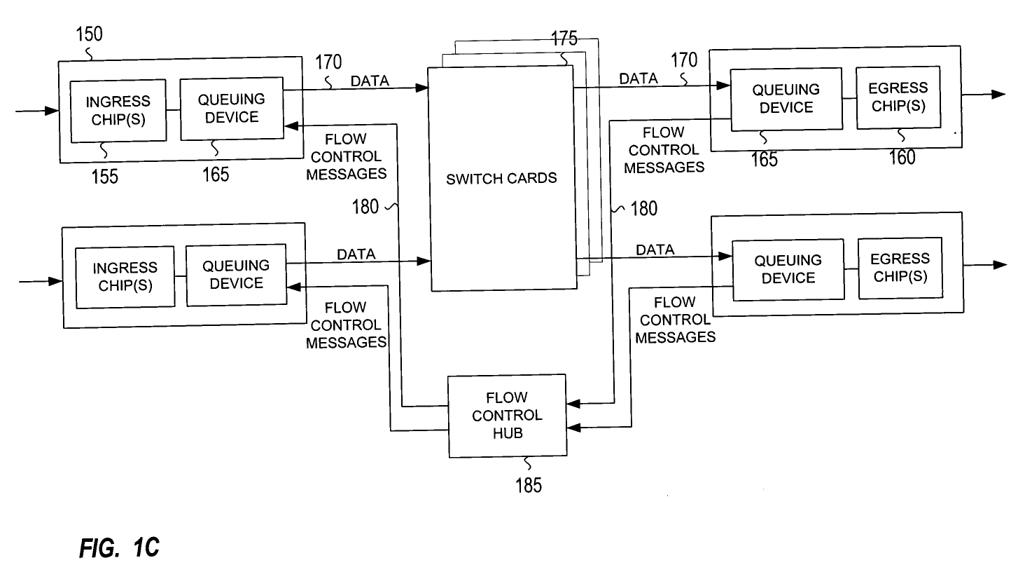

FIG. 1A illustrates an exemplary block diagram of a store-and-forward device 100, such as a packet switch or router, that receives data from multiple sources 105 (e.g., computers, other store and forward devices) over multiple communication links 110 (e.g., twisted wire pair, fiber optic, wireless). The sources 105 may be capable of transmitting data having different attributes (e.g., different speeds, different quality of service) over different communication links 110. For example, the system may transmit the data using any number of protocols including, but not limited to, Asynchronous Transfer Mode (ATM), Internet Protocol (IP), and Time Division Multiplexing (TDM). The data may be sent in variable length or fixed length packets, such as cells or frames.

The store and forward device 100 has a plurality of receivers (ingress ports) 115 for receiving the data from the various sources 105 over the different communications links 110. Different receivers 115 will be equipped to receive data having different attributes (e.g., speed, protocol). The data is stored in a plurality of queues 120 until it is ready to be transmitted. The queues 120 may be stored in any type of storage device and preferably are a hardware storage device such as semiconductor memory, on chip memory, off chip memory, field-programmable gate arrays (FPGAs), random access memory (RAM), or a set of registers. The store and forward device 100 further includes a plurality of transmitters (egress ports) 125 for transmitting the data to a plurality of destinations 130 over a plurality of communication links 135. As with the receivers 115, different transmitters 125 will be equipped to transmit data having different attributes (e.g., speed, protocol). The receivers 115 are connected through a backplane (not shown) to the transmitters 125. The backplane may be electrical or optical. The receivers 115 and transmitters 125 may be chips that are contained on line cards. A single line card may include a single receiver 115, a single transmitter 125, multiple receivers 115, multiple transmitters 125, or a combination of receivers 115 and transmitters 125. The store-and-forward device 100 will include a plurality of line cards. The chips (transmitter and receiver) may be Ethernet (e.g., Gigabit, 10 Base T), ATM, Fibre channel, Synchronous Optical Network (SONET), Synchronous Digital Hierarchy (SDH) or various other types. The line cards may contain all the same type of chips (e.g., ATM) or may contain some combination of different chip types.

FIG. 1B illustrates an exemplary detailed block diagram of the store and-and-forward device 100. The store-and-forward devise 100 has multiple ingress ports 115, multiple egress ports 125 and a switch module 140 controlling transmission of data from the ingress ports 115 to the egress ports 125. Each ingress port 115 may have one or more queues 145 (for holding data prior to transmission) for each of the egress ports 125 based on the flows associated with the data. The data is separated into flows based on numerous factors including, but not limited to, size, period of time in queue, priority, quality of service, protocol, and source and destination of data. As illustrated, each ingress port 115 has three queues for each egress port 125 indicating that there are three distinct flows.

FIG. 1C illustrates an exemplary detailed block diagram of the store and-and-forward device 100. The store-and-forward device 100 includes a plurality of line cards 150. The line cards may have one or more chips (ingress or egress) for providing communications with the external devices. As illustrated, the line cards 150 on the left have ingress chips 155 (creating ingress ports) and the line cards 150 on the right side have egress chips 160 (creating egress ports). Each line card 150 also includes a queuing device 165. When the ingress chips 155 receive data from an external source, the data is then stored in the queuing device 165. For data received at the ingress ports 155, the queuing device 165 (ingress port queuing device) is typically organized as virtual output queues based on the destination egress ports 160. When data is selected from the ingress port queuing device 165 for transmission, it is sent over a backplane 170 to one or more switch cards 175 that direct the data (provide the switching data path) to the appropriate egress ports 160. When the data is received at the egress port 160 it is queued in the queuing device 165 (egress port queuing device) prior to being transmitted therefrom.

A single line card may include a single ingress port 155, a single egress port 160, multiple ingress ports 155, multiple egress ports 160, a combination of ingress ports 155 and egress ports 165. The store-and-forward device 100 will include a plurality of such line cards.

The egress port queuing device 165 can become full if messages are coming in faster than they are being transmitted. In order to prevent the queues from overflowing, and thus losing data, the egress port 160 needs to indicate to one or more ingress ports 155 that they should stop sending data. This is accomplished by sending flow control messages from the egress ports 160 to the appropriate ingress modules 155. A separate control path 180 (backplane) for transmitting the flow control messages is provided so as not to have the flow control messages reduce the bandwidth available for the data. However, it is too expensive to have a full mesh of connections (switch cards) for transmitting flow control messages from the egress ports 160 to the ingress ports 155, therefore a central flow control hub 185 is used to gather the messages from the egress ports 160 and distribute them to the ingress ports 155. The central control hub 185 includes a scoreboard memory for tracking the flow control status of the various queues.

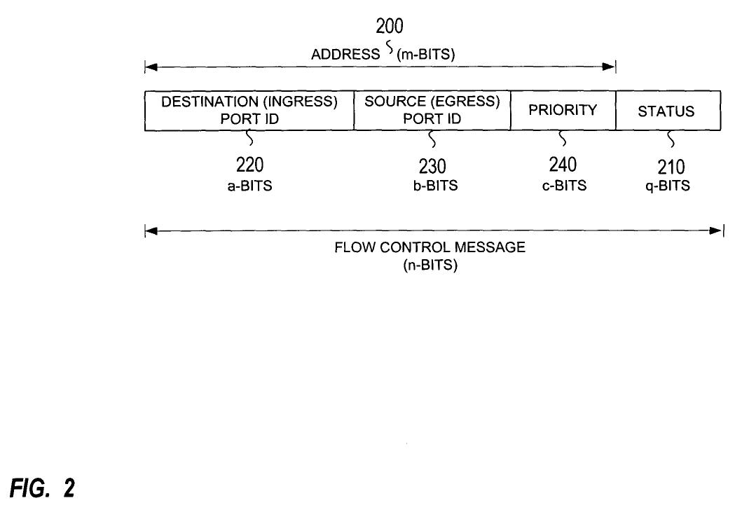

FIG. 2 illustrates an exemplary flow control message. The flow control message includes an address 200 and a status 210. According to one embodiment, the address 200 includes a destination (ingress) port ID 220, a source (egress) port ID 230, and a priority 240. The ingress port ID 220 is the ingress port or ports that the message is destined for (the ingress port that will have a flow control transition). The egress port ID 230 is the egress port from which the message came (the egress port that wishes to modify the flow of data to it). The priority 240 is the priority of data that will have a flow control transition. The priority 240 may represent the various flows (e.g., class of service, quality of service) that may be associated with each egress port and therefore have their own queue. The number of bits for each portion (ingress port ID 220, egress port ID 230 and priority 240) of the address 200 depends on the number of ports or priorities respectively. For example, if there were 64 ingress and egress ports, 6 bits would be required to identify the appropriate ports. The number of bits required for the address 200 is the number of bits required for the ingress port ID 220 plus the number of bits required for the egress port ID 230 plus the number of bits required for the priority 240. As illustrated, the ingress port ID 220 is a-bits, the egress port ID 230 is b-bits, the priority 230 is c-bits, and the address 200 is m-bits (a-bits plus b-bits plus c-bits).

The flow control message may identify the ingress port ID 220, the egress port ID 230 and the priority 240 if the flow control message is being sent from a specific egress port for a specific ingress port and priority. For example, if egress port 7 is overflowing because ingress port 6—priority 1 is transmitting too much data it may be desirable to throttle (prevent) transmission of data from just that particular ingress port and that particular priority for that particular egress port. Accordingly, the flow control message would identify port 6 for the ingress port ID 220, port 7 for the egress port ID 230, and priority 1 for the priority 240.

However, throttling data destined to a particular egress port from a particular ingress port having a particular priority may not be desired or sufficient. Rather, a particular egress port may throttle data from a plurality of ingress ports and/or a plurality of priorities. The determination of what flow (e.g., ingress port, priority) destined for the egress port should be throttled can be made based on various factors, including but not limited to, how close to overflowing the egress port is and the amount of data being transferred per flow. If the flow is to be controlled for a plurality of ingress ports and/or priorities, a flow control message would need to be sent to the plurality of ingress ports and/or priorities. A separate flow control message may be sent to each of the associated ingress ports and/or priorities, or a single flow message can be broadcast to the associated ingress ports and/or priorities. If a flow control message is broadcast, the identity of the ingress ports and/or the priorities need not be identified.

For example, if a certain priority of data (e.g., priority 1) is flooding an egress port (e.g., egress port 5), the egress port 5 may decide to throttle the transmission of priority 1 data (regardless of ingress port). If the flow control message is broadcast (e.g., to all priority 1 ingress ports), the ingress port ID is not required in the flow control message. In the alternative, instead of leaving the ingress port ID blank an ingress port ID representing all associated ingress ports could be used. For example, if there were 63 ingress ports, ID 64 could represent all ingress ports.

If a certain ingress port (e.g., ingress port 1) is flooding an egress port (e.g., egress port 7), the egress port 7 may decide to throttle transmission of data from ingress port 1 (regardless of priority). If the flow control message is broadcast (e.g., to all priorities for ingress port 1), the priority is not required in the flow control message. In the alternative, instead of leaving the priority blank a priority representing all priorities could be used. For example, if there were 3 priorities, priority 4 could represent priorities 1-3.

It is also possible that transmission to that egress port may be throttled regardless of the priority or source (ingress port). In this case, the broadcast flow control message would only require an egress port ID 230 (or in the alternative the ingress port ID 220 and the priority 240 would have values that represent all ingress ports and all priorities respectively).

The above examples illustrated flow control messages being generated from an egress port associated with some combination of ingress port and priority. It is also possible that the store-and-forward device may generate messages that control the flow for specific ingress ports or priorities, regardless of the egress port. This may be the case when the store-and-forward device changes priorities that the system is currently processing (e.g., only processing queues having highest quality of service). In this case, the egress port ID 230 would not be required (or in the alternative would be an ID that equated to all egress ports).

The status 210 can be a simple ON/OFF flow control status. An OFF message indicates that the traffic belonging to one or more queues (flows) need to be throttled (prevented) and an ON message indicates that the traffic belonging to one or more queues (flows) can be transmitted. The status 210 can be a value representing how limited the flow should be (e.g., on a continuum of 1-10 a 0 meaning no flow and a 10 meaning full flow). The number of bits required for the status 210 depends on the type of status utilized in the store-and-forward device. If the store-and-forward device uses a simple ON/OFF status only a single bit (e.g., 0 for OFF, 1 for ON) is required. However, if a continuum is used the number of bits depends on the number of positions in the continuum. For example, if 8 different positions were possible, the status 210 would require 3 bits. As illustrated the status 210 is q-bits and the overall flow control message is n-bits (m-bits for address 200 plus q-bits for status 210).

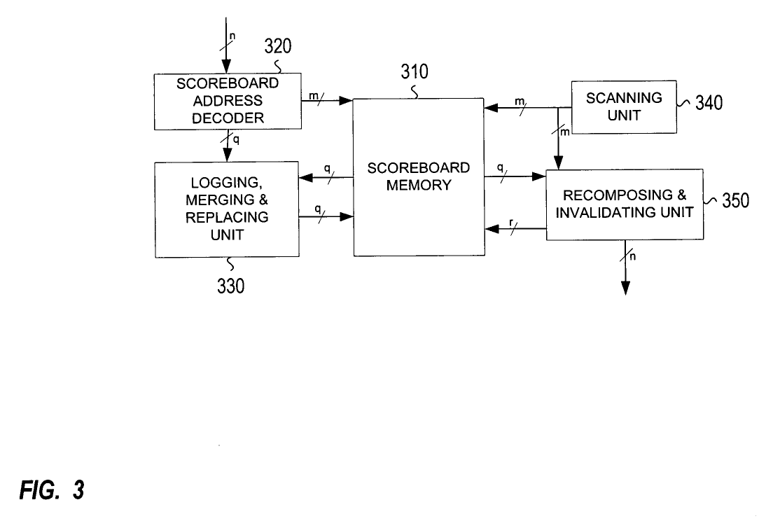

FIG. 3 illustrates an exemplary flow control hub 300, according to one embodiment. The flow control hub 300 receives flow control messages (queuing operation) from egress ports and transmits flow control messages (de-queuing operation) to ingress ports. The flow control hub 300 tracks the status of the flow control messages for each of the queues (flows). The actual flow control messages are not queued. The flow control hub 300 includes a scoreboard memory 310, a scoreboard address decoder 320, a logging, merging and replacing unit 330, a scanning unit 340, and a recomposing and invalidating unit 350. The queuing operation of the flow control hub 300 utilizes the scoreboard memory 310, the scoreboard address decoder 320, and the logging, merging, & replacing unit 330. The de-queuing operation utilizes the scoreboard memory 310, the scanning unit 340, and the recomposing & invalidating unit 350.

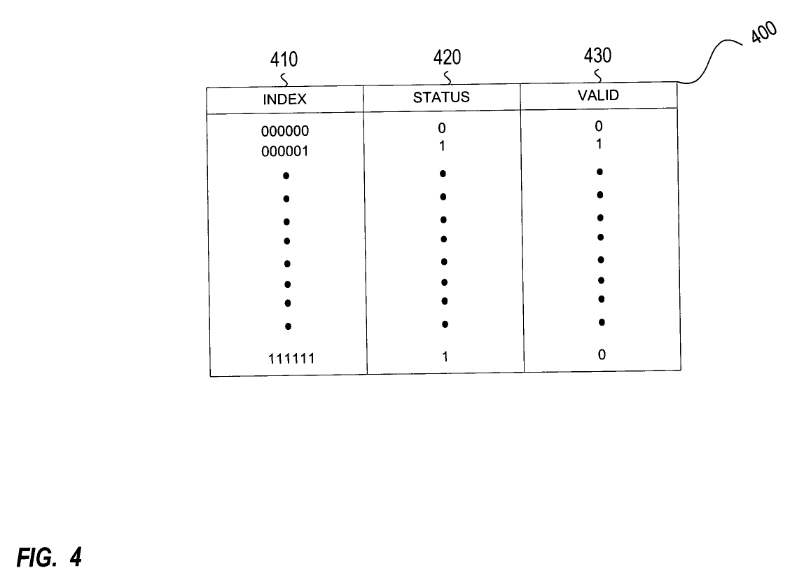

FIG. 4 illustrates an exemplary scoreboard memory 400. The scoreboard memory 400 includes an index 410 associated with a flow or combination of flows, a status 420 indicating the flow control status of the index, and a valid bit 430 indicating whether the index 410 is valid or not. The index 410 may be the same as the address 210 of the flow control messages. For example, a flow control message having an ingress port 01, egress port 10 and priority 1, may have an index of 01101 if the index was the same as the address. Alternatively, a mapping table may be utilized to map the address 210 to the applicable index 410. As previously discussed, flow control messages may be broadcast. For example, if the flow control message is to be broadcast to all the ingress ports the flow control message will either contain no ingress port ID or will contain an ingress port ID that is associated with a broadcast flow control message.

When a broadcast flow control message is received (e.g., destined to all queues (priorities) for ingress port 1), the flow control status within the scoreboard memory may be updated for all associated flows (e.g., queues (priorities) for ingress port 1). Alternatively, the scoreboard memory may have an index that represents a broadcast to the associated flows (e.g., queues (priorities) for ingress port 1). For example, if a flow control message associated with egress port 1 and priority 1 is to be broadcast to all ingress ports associated therewith, the index associated with each priority 1 ingress port destined for egress port 1 may receive a status update or a single index associated with all ingress ports for egress port 1, priority port 1 (if such an index is included in the scoreboard memory) may receive a status update.

The status 420 stores the status contained in the last flow control message associated with that index 410. The valid bit 430 indicates whether the flow control status associated with the index should be processed (sent to the appropriate queue). The valid bit 430 will be set if the status should be processed and will not be set if the status should not be processed. For example, when a flow control message is received and the status of an associated index (or indexes) is updated the valid bit is set indicating that the status can be processed. Once the status is processed (a flow control message indicating the status is sent to the applicable queue) the valid bit is turned off so that the status for that index is no longer in the queue to be processed. In the alternative, the status for the particular queue may be erased so that there is no status to process.

The scoreboard memory can be a SRAM, register block, or any other type of memory. The number of entries in the scoreboard memory is dependant on the number of possible addresses (one memory location per address) and the size of the entries is dependent on the granularity of the flow control (simple ON/OFF or continuum). The scoreboard memory will have 2^{m} q-bit entries for storing the flow control status, plus 2^{m} 1-bit entries for the valid bits. Depending on the access speed and the frequency with which the flow control messages are queued and de-queued, the scoreboard memory can be single port, dual-port, or multi-port.

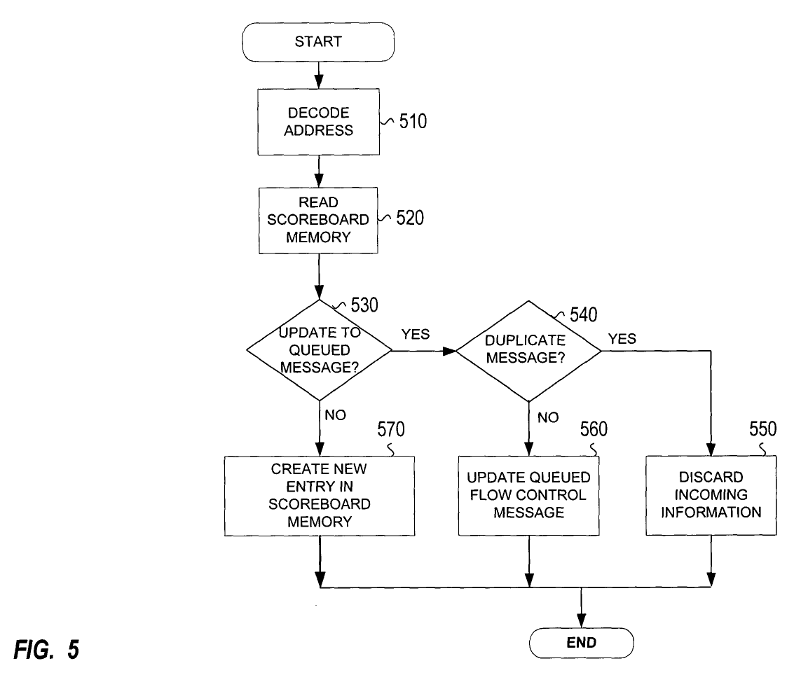

FIG. 5 illustrates an exemplary flowchart for queuing flow control messages, according to one embodiment. The egress module forwards a flow control message (n-bits), which is received by the scoreboard address decoder 320. The scoreboard address decoder 320 receives the n-bit flow control message and based upon the m-bit address 200 contained therein determines an associated index (that equates to a certain location) in the scoreboard memory 310 (510). The status from the scoreboard memory 310 for the associated index is read (520). The logging, merging, and replacing unit 330 checks whether the status that was read from the scoreboard memory 310 already has a valid message that has been queued for delivery (530). If the index already has a valid entry (530 Yes), the logging, merging, and replacing unit 330 determines if the status just received in the flow control message is the same as the status already stored in the index (540). If the statuses are the same (540 Yes), the new flow control message will be discarded without making any changes to the scoreboard memory 310 for that index (550). If the statuses were not the same (540 No), the status will be updated for that index (560). For example, if the status in the scoreboard memory 310 was ON and the flow control message contained an OFF status, the entry at the index would be updated to reflect the OFF status.

It should be noted that in the case of a simple ON/OFF status, the associated flow may already have an OFF status since the FC message changing it to an ON was not yet processed. Thus, if it was certain that the current status of the flow was the same as the newly received flow control message there would be no reason to forward the new message. Accordingly, in such a case the flow control status for that index could be invalidated or erased.

If the index does not have a valid entry (530 No), the logging, merging, and replacing unit 330 will validate the index and mark the status. It should be noted that the reason there is no valid entry could be because there is no status data for that index or that the valid bit is not set. This could be because no flow control messages were received for that particular index or that the last flow control message associated with that index was already processed and the status data was erased and/or the valid bit was deactivated.

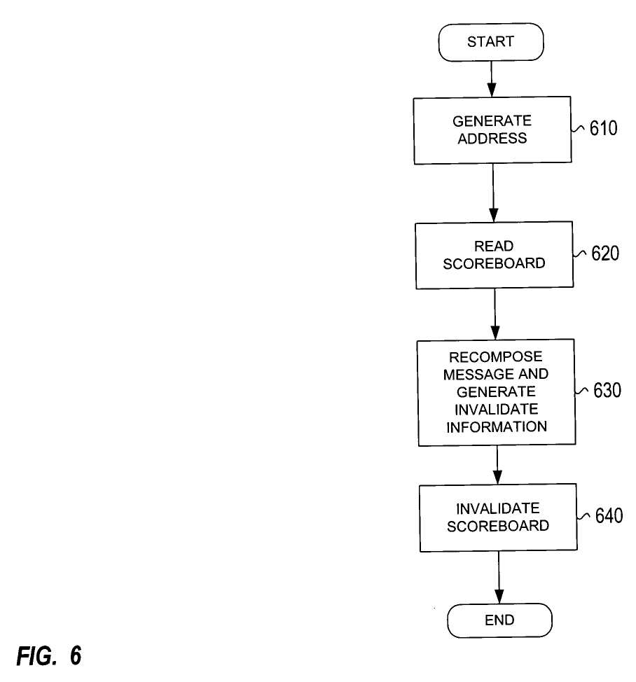

FIG. 6 illustrates an exemplary flowchart for de-queuing flow control messages, according to one embodiment. The scanning unit 340 determines which flow control message is next to be processed and then generates the index for that message so sends the index to the scoreboard memory 310 and the recomposing and invalidating unit 350 (610). The determination of the next flow control message to be processed can be done in a round-robin fashion, by date order (would require that the flow control messages were time stamped and that the time stamp was stored in the scoreboard memory), by priority, by destination port (ingress port), source port (egress port), or any other scheme, including giving priority to certain types of flow control messages or certain ports.

The scoreboard memory 310 retrieves the status associated with the index and transmits it to the recomposing and invalidating unit 350 (620). The recomposing and invalidating unit 350 uses the index from the scanning unit 340 and the status from the scoreboard memory 310 to recompose the flow control message to be sent out (630). The recomposing and invalidating unit 350 also generates an invalidate message (e.g., changes valid bit 430 from 1 to 0) for the index and transmits it to the scoreboard memory 310 so that the system knows that there is not a valid flow control message to process for that index anymore (640). In the alternative, the status contained in the scoreboard memory 310 for that index may be erased.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” appearing in various places throughout the specification are not necessarily all referring to the same embodiment.

Different implementations may feature different combinations of hardware, firmware, and/or software. For example, some implementations feature computer program products disposed on computer readable mediums. The programs include instructions for causing processors to perform techniques described above.

The various embodiments are intended to be protected broadly within the spirit and scope of the appended claims.

1. A flow control hub, comprising:
a scoreboard memory device to maintain flow control status for a plurality of flows, wherein each of the flows is identified by an associated index;
an address decoder to receive a flow control message and to determine the associated index for the flow control message; and
an updater to update the flow control status in said scoreboard memory device based on the received flow control message.

2. The apparatus of claim 1, wherein the plurality of flows may be based on at least some subset of source, destination, protocol, priority, class of service, and quality of service.

3. The apparatus of claim 1, wherein the flow control message is received in response to capacity of a queue.

4. The apparatus of claim 1, wherein the flow control message is received in response to changing priorities.

5. The apparatus of claim 1, wherein said updater includes a comparator to compare the received flow control message with the flow control status maintained in said scoreboard memory device and said updater updates the flow control status maintained in said scoreboard memory device based on the comparison.

6. The apparatus of claim 5, wherein said updater updates the flow control status maintained in said scoreboard memory device to reflect status identified in the received flow control message if the comparator determines the associated index has either no status, no valid status or a different status than the received flow control message.

7. The apparatus of claim 5, wherein said updater makes no changes to the flow control status maintained in said memory device if the comparator determines the associated index has the same flow control status as the received flow control message.

8. The apparatus of claim 1, wherein said updater discards the received flow control message.

9. The apparatus of claim 1, further comprising a message generator to generate a flow control message for a particular flow based on the flow control status maintained in said scoreboard memory device for the particular flow.

10. The apparatus of claim 9, further comprising a selector to select the particular flow.

11. The apparatus of claim 1, wherein the flow control message is a broadcast message.

12. The apparatus of claim 11, wherein said updater updates the flow control status for all flows associated with the broadcast message.

13. The apparatus of claim 1, wherein said address decoder utilizes a mapping table to determine the associated index.

14. A flow control hub, comprising:
a scoreboard memory device to maintain flow control status for a plurality of flows, wherein each of the flows is identified by an associated index;
a message generator to generate a flow control message for a particular flow based on the flow control status maintained in said scoreboard memory device for the particular flow; and
a selector to select the particular flow.

15. The apparatus of claim 14, wherein said message generator transmits the generated flow control message to a queue associated with the particular flow.

16. The apparatus of claim 15, wherein said message generator invalidates the flow control status maintained in said scoreboard memory device for the particular flow.

17. The apparatus of claim 15, wherein said message generator erases the flow control status maintained in said scoreboard memory device for the particular flow.

18. The apparatus of claim 14, further comprising
an address decoder to receive a flow control message and to determine an associated index; and
an updater to update the flow control status in said scoreboard memory device based on the received flow control message.

19. A method, comprising:
maintaining a flow control status for a plurality of flows in a memory device, wherein each of the flows is identified by an associated index;
generating a flow control message for a particular flow based on the flow control status maintained in the memory device for the particular flow; and
selecting the particular flow.

20. The method of claim 19, further comprising transmitting the generated flow control message to a queue associated with the particular flow.

21. The method of claim 20, further comprising invalidating the flow control status maintained in the memory device for the particular flow.

22. The method of claim 19, further comprising
receiving a flow control message;
determining an associated index for the flow control message; and
updating the flow control status maintained in said memory device based on the received flow control message.

23. A method comprising
maintaining a flow control status for a plurality of flows in a memory device, wherein each of the flows is identified by an associated index;
receiving a flow control message;
determining an associated index for the received flow control message;
updating the flow control status maintained in said memory device based on the received flow control message.

24. The method of claim 23, wherein said updating includes comparing the received flow control message with the flow control status maintained in the memory device and updating the flow control status maintained in the memory device based on results of the comparing.

25. The method of claim 24, wherein said updating includes updating the flow control status maintained in the memory device to reflect status identified in the received flow control message if the comparing determines the associated index has either no status, no valid status or a different status than the received flow control message.

26. The method of claim 24, wherein said updating includes making no changes to the flow control status maintained in the memory device if the comparing determines the associated index has the same flow control status as the received flow control message.

27. The method of claim 23, further comprising discarding the received flow control message.

28. The method of claim 23, further comprising
generating a flow control message for a particular flow based on the flow control status maintained in the memory device for the particular flow; and
selecting the particular flow.

29. The method of claim 23, wherein said receiving includes receiving a broadcast flow control message.

30. The method of claim 29, wherein said updating includes updating the flow control status for all flows associated with the broadcast message.

31. The method of claim 23, wherein said determining includes utilizing a mapping table to determine the associated index.

32. A store and forward device comprising:
a plurality of Ethernet cards including
a plurality ingress ports to receive data from external sources and transmit the data based on flow of the data, wherein each ingress port has a plurality of ingress queues associated with a plurality of flows, and wherein transmission of data from a particular queue is controlled at least in part by a flow control status associated with the queue; and
a plurality of egress ports to receive data from at least a subset of the plurality of flows, wherein each egress port has an egress queue for holding the data prior to transmission, and wherein each egress queue issues flow control messages based at least in part on capacity of the egress queue;
a backplane to connect the plurality of Ethernet cards together; and
a flow control hub to receive flow control messages, maintain a flow control status for each flow based on the received flow control messages, select next flow to receive flow control message, and generate and forward flow control message to queue associated with the next flow.

33. The device of claim 32, wherein said flow control hub includes a memory device to maintain the flow control status for the plurality of flows, wherein each of the flows is identified by an associated index.

34. The device of claim 33, wherein said flow control hub further includes
an address decoder to receive the flow control messages from the egress queues and to determine an associated index;
an updater to update the flow control status in the memory device based on the received flow control message;
a message generator to generate a flow control message for a particular flow based on the flow control status maintained in the memory device for the particular flow and to transmit the generated flow control message to the particular flow; and
a selector to select the particular flow.
